(19) United States
(12) Patent Application Publication
(10) Pub. No.: US 2014/0251860 A1
(43) Pub. Date: Sep. 11, 2014

(54) CLEANING AGENT FOR PAWS OF DOMESTIC ANIMALS

(71) Applicant: Joker AG, Kerzers (CH)

(72) Inventor: Meinrad Flury, Kerzers (CH)

(73) Assignee: JOKER AG, Kerzers (CH)

(21) Appl. No.: 14/352,680

(22) PCT Filed: Oct. 1, 2012
(86) PCT No.: PCT/EP2012/069364

§ 371 Date: Apr. 17, 2014

(30) Foreign Application Priority Data
Oct. 19, 2011 (CH) 01697/11

(51) Int. Cl. C11D 3/20; B65D 85/00

(52) U.S. Cl. CPC C11D 3/20; B65D 85/70
USPC 206/525; 510/160

(57) ABSTRACT

A means is suggested for cleaning domestic animal paws, by means of which solid particles can be removed from the domestic animal paws. This consists of a highly viscous modelling mass with a viscosity of 50 000-150 000 mPa·s, preferably of 80-120 mPa·s. This compound is formed from natural polygalactomannans and also 75-95% by weight of bound water and contains a disinfecting solution from the group of saturated monovalent alcohols. Preferably, the compound additionally contains lubricating, anti-inflammatory, disinfecting, antiseptic and regenerative agents. The compound is created such that contaminations can be kneaded into the compound by means of a few kneading movements. For use, the compound (3) is introduced into a container (1) which has a flat recess for accommodating the domestic animal paw cleaning means. The compound is protected from drying out by means of a lid (4), preferably made of a soft plastic, which covers the recess in a positive-fitting manner.

### REFERENCE TO RELATED APPLICATIONS

This application is the US national phase entry of International Patent Application no. PCT/EP2012/069364, filed Oct. 1, 2012, which claims priority to Swiss patent application no. 01697/11 filed Oct. 19, 2011.

### FIELD OF THE INVENTION

The present invention relates to a domestic animal paw cleaning means for removing solid particles from domestic animal paws.

### BACKGROUND OF THE INVENTION

It is a long-known problem that following their periods outdoors domestic animals, particularly dogs and cats, have paws that are dirtied to a greater or lesser extent, depending on the weather, and consequently carry this dirt into the house. The dog owner knows this and will clean the paws with a cleaning cloth or a brush when they come back home after an outing with the dog. Such cleaning is often difficult to realize, as many dogs reluctantly go through such cleaning.

This is more problematic in the case of cats, which are free to go out. Even if one only allows the cat into the house when it meows, then a cleaning of the paws is barely possible. Thus, it is even more problematic if a so-called cat flap is present, through which the cat has free entry and exit. In addition to the difficulty of cleaning domestic animal paws, the care thereof is also difficult. Dogs and cats also always carry bacterial, fungicidal, viral and sporide contaminations on the paws. These cannot be removed with a brush or a dry cleaning cloth. Although veterinary medicines are available on the market which are suitable for caring for paws, such agents are in practice only used sporadically or in the case of an injury or inflammation on the paws.

Of course, diverse socks or shoes are known for domestic animals, which should be put on the domestic animals before going for a walk.

By contrast, in the document KR 20040099871, a type of vacuum cleaner is suggested, in order to clean the fur of a domestic animal in the case of bacterial or parasitic infection.

The Japanese patent JP 4142722 suggests another solution. Here, a paw doormat together with cleaning gloves is suggested.

Finally, in the document U.S. Pat. No. 6,745,721 B, a device is suggested with rotating brushes accommodated therein and a doormat, which are accommodated together in a housing.

### SUMMARY

It is now the object of the present invention to create a domestic animal paw cleaning composition which can be used for a domestic animal for quicker and simpler paw cleaning.

It is a further object of the present invention to offer optimal use options of the domestic animal paw cleaning composition.

A domestic animal paw cleaning composition for removing solid particles from domestic animal paws is provided that comprises lubricating, anti-inflammatory, disinfecting, antiseptic and regenerative agents added to a highly viscous modelling mass with a viscosity of ˜50 000 to 150 000 mPa·s, preferably of 80 000 to 120 000 mPa·s, wherein the composition is created in such a manner that contaminations can be kneaded into the composition by means of a few kneading movements.

The second object is achieved by inserting the cleaning composition in a recess of a flat container that can be sealed with a lid or flap.

Preferably, the domestic animal paw cleaning means according to the invention consists of a modelling mass which contains natural polygalactomannans, 75 to 95% by weight of bound water and a disinfecting solution from the group of saturated monovalent alcohols. Such a modelling mass with a particularly high proportion of bound water is an ideal basic compound for the introduction of diverse active agents which have a corresponding lubricating, anti-inflammatory, disinfecting, antiseptic and regenerative effect.

Further advantageous embodiments of the domestic animal paw cleaning means according to the invention, and the meaning and effects thereof are explained in the following.

### BRIEF DESCRIPTION OF THE DRAWINGS

The preferred use of the domestic animal paw cleaning means according to the invention is illustrated in the attached drawings. In the figures:

FIG. 1 shows a perspective side view of a preferred container for using the composition with partly lifted lid, and

FIG. 2 shows the same container with closed lid.

### DETAILED DESCRIPTION

The basis for the domestic animal paw cleaning means for removing solid particles from domestic animal paws suggested here is based on a modelling mass which has already been known for many years in certain formulas as a children's toy. This compound was disclosed in a corresponding adaptation in EP 1373449 B. The applicant has provided this composition under its registered trade mark “Cyber-Clean®” for cleaning, in particular for the cleaning of computer keyboards. Corresponding agents caring for domestic animal paws are now added to this composition.

So that the modelling mass is particularly absorptive, it is suggested to form this modelling mass from natural polygalactomannans with a proportion of 75% by weight to 95% by weight of bound water, which contains a disinfecting solution from the group of saturated monovalent alcohols. Guar gum and locust bean gum are particularly suitable as natural polygalactomannans.

In one embodiment, the domestic paw cleaning composition comprises the following components:

| | | |
|---|---|---|
| Water (H₂O: | 65-75% | by weight |
| Ethanol | 10-20% | by weight |
| Propanetriol | 5-8% | by weight |
| Native guar | 3-7% | by weight |
| Boron (as boric acid) | 0.1-0.5% | by weight |
| Fragrance | 0.001-0.1% | by weight |
| Colouring | 0.001-0.003% | by weight. |

For the daily care of domestic animal paws, it makes sense in particular to add a lubricating and regenerative agent to the polygalactomannan. Lanolin is particularly suitable for this. Lanolin has a regenerative effect, both for the skin and for the hair and keratin portions of the paws.

Furthermore, one can add up to 1% by weight of phenoxylethanol as anti-inflammatory bactericide. Phenoxylethanol is a colorless liquid with a weakly aromatic rose-like odor. Phenoxylethanol is also slightly water-soluble. It is additionally advantageous to add various skin- or cell-regenerating agents to the modelling mass. Allantoin in particular promotes cell building and thus acts in a cell-regenerative manner. Dexpanthenol, which may likewise be introduced in small amounts, likewise acts in a regenerative manner, dexpanthenol also being used for wound healing.

Injuries to the paws count amongst the most common injuries for domestic animals. It therefore makes complete sense to add such wound-healing agents to the modelling mass. It likewise makes sense to also correspondingly add disinfecting agent such as preferably iodine. Domestic animals often have very small injuries on the paws which even the animal themselves and the domestic animal owner does not notice at all. If, however, the paws of a domestic animal daily come into contact with the domestic animal paw cleaning composition which contains lubricating, anti-inflammatory, disinfecting, antiseptic and regenerative agents, then it is thereby ensured that such small and very small injuries do not lead to severe infections.

The domestic animal paw cleaning composition according to the invention can preferably additionally contain polyhexanide as antiseptic. This is particularly suitable as wound antiseptic for treating infected wounds. Due to the good tissue tolerance and the clinically obvious wound-healing promotion, polyhexanide is particularly suitable for treating poorly healing, chronic and very sensitive wounds.

In the preferred use, the domestic animal paw cleaning composition is inserted in a flat container 1 with a relatively shallow recess 2, in which the domestic animal paw cleaning composition 3 is inserted. Thanks to the defined shape, a relatively large area is made available. The container can be hermetically sealed with a soft lid 4 in order to prevent drying out. Accordingly, the lid 4 fits positively into the opening of the recess 2. The lid 4 can be removed simply by means of a gripping tab 5.

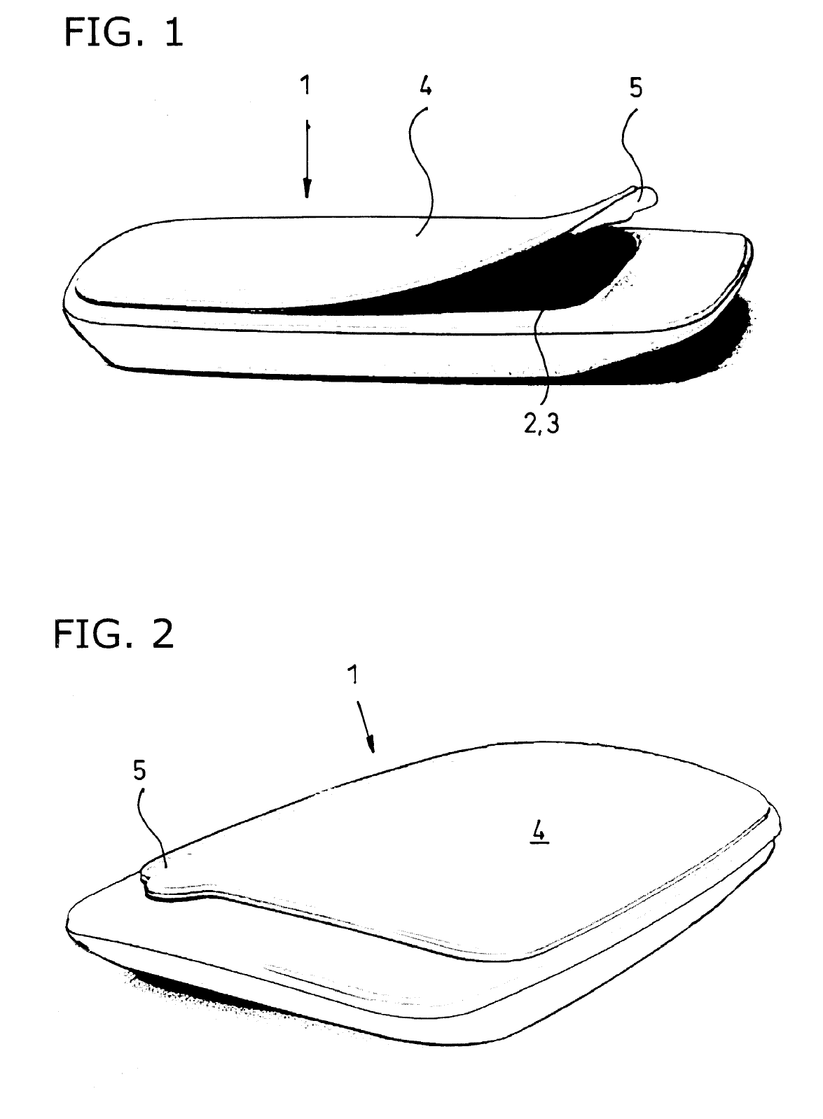

A possible embodiment of such a container is illustrated in FIGS. 1 and 2. So that the domestic animals do not have any unwillingness to step onto the modelling mass, one will preferably apply at least one essential oil onto the same as odor-imparting agent. Chamomile, arnica, honey and valerian are preferably suitable for this. On the one hand, the odors of these essential oils are very popular amongst various domestic animals. Chamomile, arnica and honey in particular are appreciated by dogs, whilst valerian is particularly attractive for cats. The advantage of these essential oils also consists in their additionally having an antiseptic effect. If one uses the domestic animal paw cleaning composition in a flat container which is chosen and adapted in such a manner in terms of dimensions that this flat container fits practically as an insert in a domestic animal portal or in a domestic animal flap, then the domestic animal must necessarily walk over the means according to the invention. In such a case, this may also in practice be fragrance-free.

If a domestic animal has walked over the composition a number of times, then the domestic animal owner will remove this composition from the flat recess, briefly knead it and re-insert it. In this manner, the composition can be practically regenerated, as the new available surface is practically fully effective again. The composition consequently only needs to be replaced after a number of weeks. It is also not necessary for the domestic animal owner to wear special protective gloves for kneading the composition, as all of the added active agents can absolutely also be used in human medicine and the domestic animal owner practically obtains a hand-care means.

### REFERENCE LIST

### 1 Container

### 2 Recess

### 3 Means

### 4 Lid

5 Gripping tab

1. A domestic animal paw cleaning composition for removing solid particles from domestic animal paws, comprising:
skin-lubricating, anti-inflammatory, disinfecting, antiseptic and regenerative agents;
a highly viscous modelling mass; and
lanolin as a lubricating and regenerative agent for regenerating skin, keratin and hair,
wherein the composition is created in such a manner that contaminants can be kneaded into the composition by means of a few kneading movements.

2. The domestic animal paw cleaning composition according claim 1, wherein the modelling mass comprises: natural polygalactomannans, 75 to 95% by weight of bound water and a disinfecting solution selected from the group consisting of saturated monovalent alcohols.

3. The domestic animal paw cleaning composition according to claim 1, further comprising zinc oxide as an antiseptic disinfecting agent.

4. The domestic animal paw cleaning composition according claim 1, further comprising up to 1% by weight of phenoxylethanol as a bactericide.

5. The domestic animal paw cleaning composition according to claim 1, further comprising allantoin as a regenerative agent for promoting cell building and cell regeneration.

6. The domestic animal paw cleaning composition according to claim 1, further comprising dexpanthenol as a regenerative agent for wound healing.

7. The domestic animal paw cleaning composition according to claim 1, further comprising iodine as a disinfecting agent.

8. The domestic animal paw cleaning composition according to claim 1, further comprising at least one essential oil.

9. The domestic animal paw cleaning composition according to claim 1, wherein the modelling mass comprises:

| | | |
|---|---|---|
| Water (H₂O: | 65-75% | by weight |
| Ethanol | 10-20% | by weight |
| Propanetriol | 5-8% | by weight |
| Native guar | 3-7% | by weight |
| Boron (as boric acid) | 0.1-0.5% | by weight |
| Fragrance | 0.001-0.1% | by weight |
| Colouring | 0.001-0.003% | by weight |

10. A method for cleaning the paws of a domestic animal, comprising contacting the paws with the domestic animal paw cleaning composition according to claim 1.

11. The method according to claim 12, wherein the flat container is arranged in or in front of a flap or a portal for entry of domestic animals.

12. The method according to claim 10, wherein the domestic animal paw cleaning composition is provided in a flat container comprising a recess in which the domestic paw cleaning composition in inserted, and a lid or flap that seals the container.

13. The domestic animal paw cleaning composition according to claim 8, wherein the at least one essential oil is selected from the group consisting of: chamomile, arnica, honey and valerian.

14. A container comprising a recess in which is inserted the domestic paw cleaning composition according to claim 1, wherein the container is flat and comprises a lid or flap that seals the container.
